(19) United States
(12) Patent Application Publication
(10) Pub. No.: US 2014/0247116 A1
(43) Pub. Date: Sep. 4, 2014

(54) ROBOTIC INVENTORY SYSTEMS

(71) Applicant: Bar Code Specialties, Inc. (DBA BCS Solutions), Garden Grove, CA (US)

(72) Inventor: William Edward Davidson, Durham, NC (US)

(73) Assignee: Bar Code Specialties, Inc. (DBA BCS Solutions), Garden Grove, CA (US)

(21) Appl. No.: 14/274,087

(22) Filed: May 9, 2014

Related U.S. Application Data
(63) Continuation of application No. PCT/US2012/064507, filed on Nov. 9, 2012.
(60) Provisional application No. 61/558,846, filed on Nov. 11, 2011.

(51) Int. Cl. G06Q 10/08; G06K 7/10; G06K 7/00

(52) U.S. Cl. CPC G06Q 10/087; G06K 7/0008; G06K 7/10297; G06K 7/10376; G06K 2007/10504; Y10S 901/01; Y10S 901/46
USPC 340/10.1; 901/1; 901/46

(57) ABSTRACT

Embodiments of a robotic inventory system are provided that include a mobile robot for inventorying an inventory area, such as store or warehouse. The mobile robot can move through the inventory area collecting data from tagged items (e.g., RFID tags). Based on the collected data, the robotic inventory system can determine the items in the inventory area and the location of those items. In some embodiments, no additional infrastructure is needed for the installation of the robotic inventory system. This can allow, for example, the inventorying system to be shipped to an end customer and used by the end customer without having a professional installer setup the robot and/or the inventorying system.

### PRIORITY CLAIM AND CROSS-REFERENCE TO RELATED APPLICATIONS

This is a continuation application of Patent Cooperation Treaty Application No. PCT/US2012/064507, filed on Nov. 9, 2012 and entitled “Robotic Inventory Systems,” which claims the benefit of U.S. Provisional Patent Application No. 61/558,846, filed on Nov. 11, 2011 and entitled “Robotic Inventory Systems,” the entire contents of both of which are hereby incorporated by reference herein and made part of this specification for all that they disclose.

### BACKGROUND

A common challenge in many businesses is keeping track of inventory. This challenge is especially intense when there is high product volume, a diverse product line, and multiple sources of product movement or inventory change. In recent years, electronic systems have helped to address this challenge. For example, inventory tracking has been aided by attaching small electronic tracking devices to products that can permit an electronic system to obtain inventory information about the products.

In some systems, these electronic tracking devices comprise Radio-frequency identification (RFID) technology. RFID devices use radio waves to transfer data from an electronic tag, called an RFID tag or label, to an RFID reader. Generally, the RFID tag is attached to an object for the purpose of identifying and tracking the object to which the RFID tag is attached. Some RFID tags can be read from several meters away and beyond the line of sight of the reader.

The RFID tag's information is stored electronically. Generally, the RFID tag includes a small radio frequency (RF) transmitter and receiver. An RFID reader transmits an encoded radio signal to interrogate the tag. The tag receives the message and responds with its identification information. Many RFID tags do not use a battery. Instead, the tag uses the radio energy transmitted by the reader as its energy source. For example, passive tags reflect the reader's transmissions back to the reader and modulate that reflection. The RFID system design can include a feature for discriminating between several tags that might be within the range of the RFID reader.

Generally, inventorying of RFID-tagged items is performed manually by a human clerk with a handheld RFID reader. However, this typical method of inventorying electronic tags has a margin of error due to the manual nature of the operation. For example, a worker moving through a storage facility with an RFID reader can miss inventorying particular areas due to mistake, becoming distracted during the operation, forgetting about areas, or rushing to finish the operation. Moreover, manual inventorying of electronic tags can be very expensive over time.

### SUMMARY

Automated systems for detecting electronic inventory tags can be used to provide more consistent inventorying results. Typically, automated systems may utilize arrays of overhead readers and exciters, arrays of overhead bidirectional phased array systems and/or smart shelving and smart hanging rails. These automated systems can give near real time inventory of the store and can, to varying degrees, give the location of any given item in the store.

However, some overhead automated systems may cost significantly more than a handheld reader and a full time clerk even for comparatively small facilities. Typically, these automated systems do not scale well, with costs climbing rapidly as the store size and population of items grows. These automated systems can also require considerable setup and infrastructure to install, which is expensive, and can conflict with the store's decor. In many cases the system may need to be re-installed or calibrated if the store display scheme is changed significantly.

In addition, the read efficacy of the above automated systems, especially the overhead systems, tends to be lower than that of a handheld reader because the read ranges are generally much longer. The moving handheld reader can also mean that the incident angle of the radio frequency (RF) beam to the tag is continuously changing so that even if the tag is shielded at one angle it can likely be read as the handheld continues its motion. While some of these issues with automated systems can be mitigated by a carefully designed installation or by adding more antennas to the automated reading system, these solutions further increase the costs of these automated systems.

Therefore, there is a need for an automated reading system with acceptable effectiveness and accuracy and diminished cost. In some embodiments, an inventory system is provided that includes a mobile robotic unit that can conduct inventory procedures in a scalable manner, functioning effectively with appropriate modifications in small stores or other facilities as well as in large facilities (e.g., around 10,000 square feet or more). In some embodiments, no additional physical infrastructure among the inventoried products is needed for the installation. This can allow, for example, the inventorying system to be shipped to an end customer and used by the end customer without having a professional installer setup the robot and/or the inventorying system.

In some embodiments, a robotic inventory system is configured to operate during a facility's down time (e.g., overnight or when otherwise closed to normal operations). In some embodiments, the inventory system provides a relatively low cost, scalable system in comparison to overhead and smart shelf systems and the operator-intensive manual inventory process.

### BRIEF DESCRIPTION OF THE DRAWINGS

The drawings are provided to illustrate example embodiments described herein and are not intended to limit the scope of the disclosure. Throughout the drawings, reference numbers may be re-used to indicate correspondence between referenced elements.

FIG. 1 is a block diagram of a robotic inventory system for inventorying items in a store (e.g., department store, grocery store, etc.), warehouse, or other storage area;

FIG. 2 is a block diagram of an embodiment of a mobile robot of

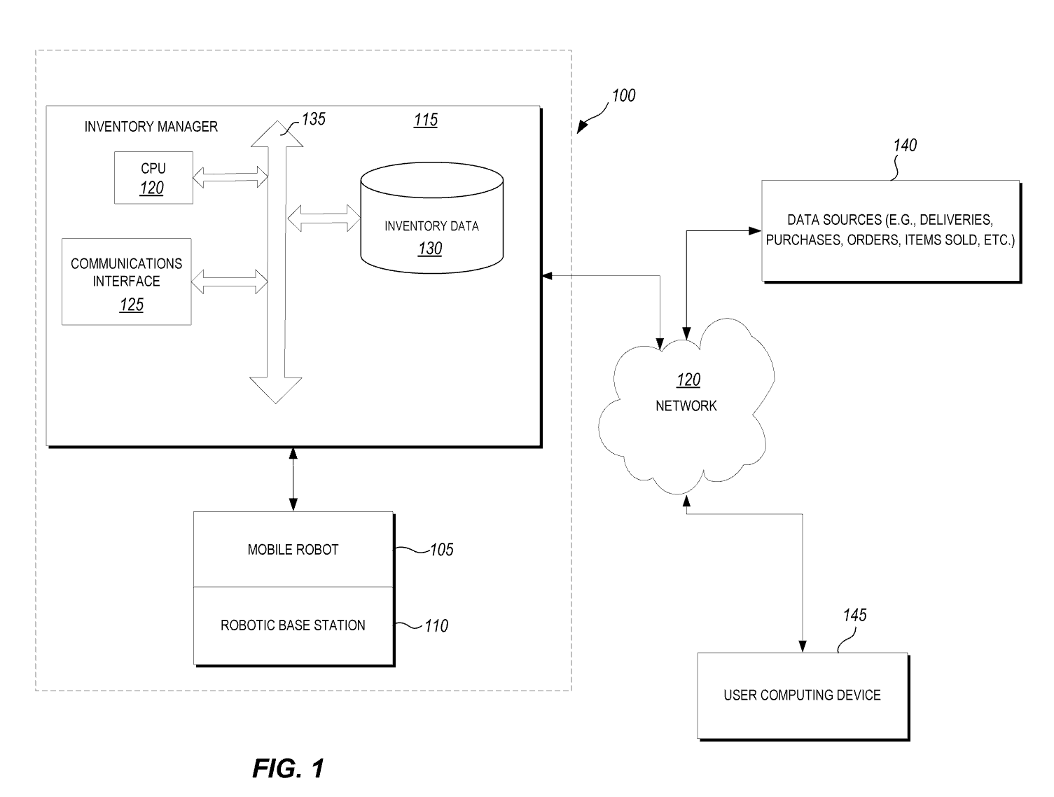

FIG. 1;

FIG. 3 schematically illustrates an embodiment of a location determination process for an RFID tag, which may be used by the robotic inventory system of FIG. 1;

FIG. 4 illustrates a flowchart of an embodiment of an inventory routine, which may be used by the robotic inventory system of FIG. 1;

FIG. 5 illustrates a flowchart of an embodiment of a navigation routine, which may be used by the robotic inventory system of FIG. 1; and

FIG. 6 illustrates an example depiction of a mobile robot moving through a store while detecting tags associated with items in the store.

### DETAILED DESCRIPTION

Various aspects of the disclosure will now be described with regard to certain examples and embodiments, which are intended to illustrate but not to limit the disclosure. Nothing in this disclosure is intended to imply that any particular feature or characteristic of the disclosed embodiments is essential. The scope of protection of certain inventions is defined by the claims. For ease of reference, the description below uses the term “store” in discussing the robotic inventory system. The term “store” can refer to any type of area where products are located, including but not limited to storage areas, warehouses, retailer facilities, etc.

### Examples of Robotic Inventory Systems

FIG. 1 is a block diagram of a robotic inventory system 100 for inventorying items in a store (e.g., department store, grocery store, etc.), warehouse, or other storage area. The robotic inventory system 100 can include a mobile robot 105, a robotic base station 110 and an inventory manager 115. Components of the robotic inventory system 100 can communicate over a network, direct link (e.g., wired or wireless), or other communications link. In addition, the robotic inventory system 100 can be connected to external systems, devices, or data sources via a network 120 or other communications link.

In some embodiments, the robot 105 is an electro-mechanical machine that is guided by computer and/or electronic programming. In some embodiments, the robot 105 can be autonomous, semi-autonomous or remotely controlled. The robot 105 can include one or more memory devices, processors, sensors, scanners, transmitters, receivers, power systems (e.g., batteries or wireless charger), location tracking systems and/or motors.

The inventory manager 115 can include one or more central processing units (CPUs) 120, an inventorying module 125 for performing inventory operations, and data storage 130 for storing inventory data, such as a list of inventory items, expected inventory items, previous inventory records (e.g., inventory lists from past days), expected location of inventory items, and other inventory-related data. The components can be connected via a communications medium 135, such as a system bus or network, which can be the same network 120 described above or a different network. For example, the communications medium 135 may be a local area network while the network 120 is wide area network. The robotic inventory system 100 components can be part of a single computing device or part of one or more computing systems comprising one or more computing devices. For example, in some embodiments, the inventory manager 115 can be part of the mobile robot 105 or robotic base station 110. In some embodiments, the inventory manager 115 can be a separate device or devices.

The inventory manager 115 can be in communication with external data sources 140, which can include store or warehouse data. For example, the inventory 115 manager can receive inventory-change data, such as data regarding deliveries, purchases, invoices or orders, reports on items, and other inventory-related data from the data sources 140. The inventory manager 115 can store that inventory-change data in its data storage 130 and can use such data during inventorying operations. For example, the inventory manager 115 can receive data associating electronic transmitters or transponders, such as RFID tag identifiers, with particular items, which data the inventory manager 115 can use to identify items in the storage area.

A user computing device 145, such as a desktop computer, laptop, smart phone (e.g., an (PHONE or ANDROID device), tablet or other mobile device, may be able to communicate with the robotic inventorying system 100 via the network 120. In some embodiments, the user computing device 145 receives reports, status updates, and/or other messages from the robotic inventorying system 100. For example, the robotic inventorying system 100 can send an alert to a store manager that particular inventory items are running low. The store manager can then re-order the items by communicating with the store's suppliers. In some embodiments, the robotic inventorying system 100 may automatically place an order with suppliers. In some embodiments, the robotic inventorying system 100 can provide updates on inventory operations to the user computing device 145 that allow the user to track the progress of the inventory operation. This can allow a centrally located manager to monitor one or multiple robotic inventorying systems 100 remotely.

In some embodiments, the user computing device 145 can provide instructions to the robotic inventorying system 100, such as setting a time for an inventory operation, initiating or cancelling an inventory operation, as well as other commands. For example, a store manager can remotely program the robotic inventorying system 100 to perform inventory operations. This can be useful when the inventory operations are done after closing as the store manager can program the robotic inventorying system 100 from home or some other location away from the store.

In some embodiments, the robot 105 can dock with the robotic base station 110 to charge. In some embodiments, the robot 105 and the robotic base station 110 have communication interfaces, such as wireless transmitters and receivers or wired data interfaces, for communicating with each other. For example, the mobile robot 105 may communicate the RFID readings or inventory data that it collects during an inventory operation to the robotic base station 110. In turn, the base station 110 can report those readings or inventory data to the inventory manager 115.

In some embodiments, some or all of the functions of the base station 110 are integrated into the robot. For example, the robot 105 may be able to communicate directly with the inventory manager 115 and the robot 105 directly reports the inventory data to the inventory manager 115. In some embodiments, some or all of the functions of the inventory manager 115 may be integrated into the robot 105. For example, the robot 105 may analyze readings and determine the current inventory in the store.

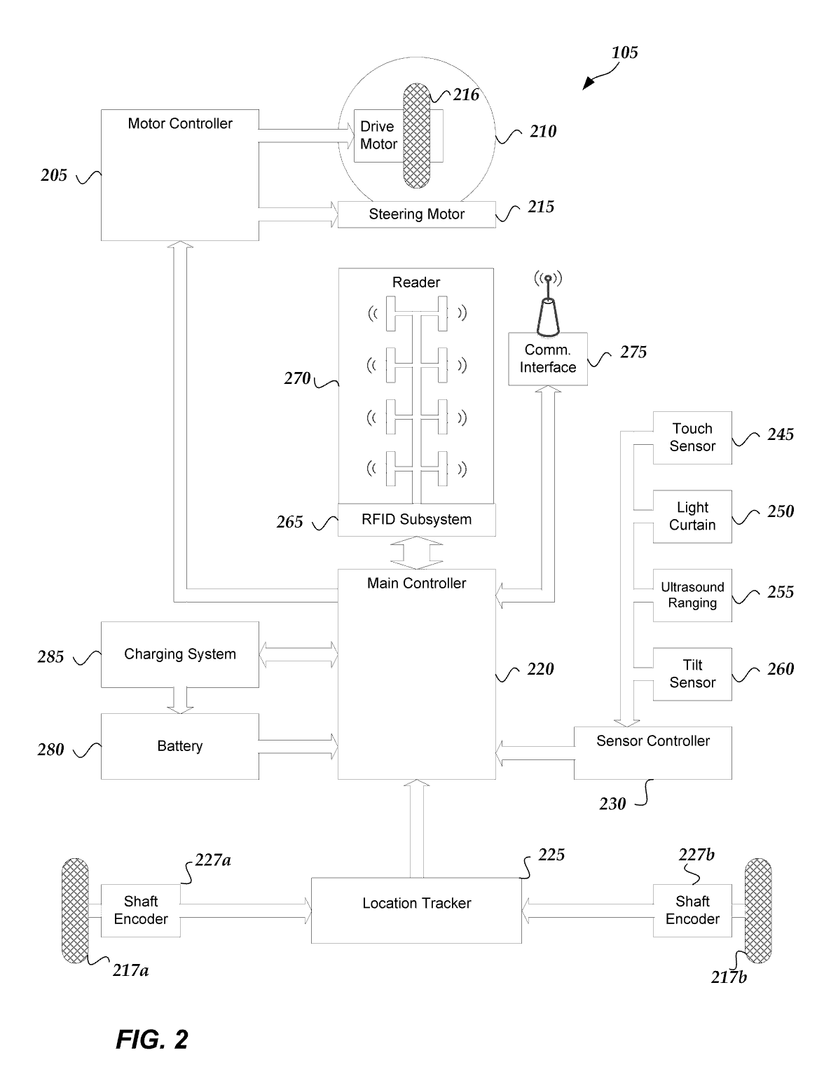

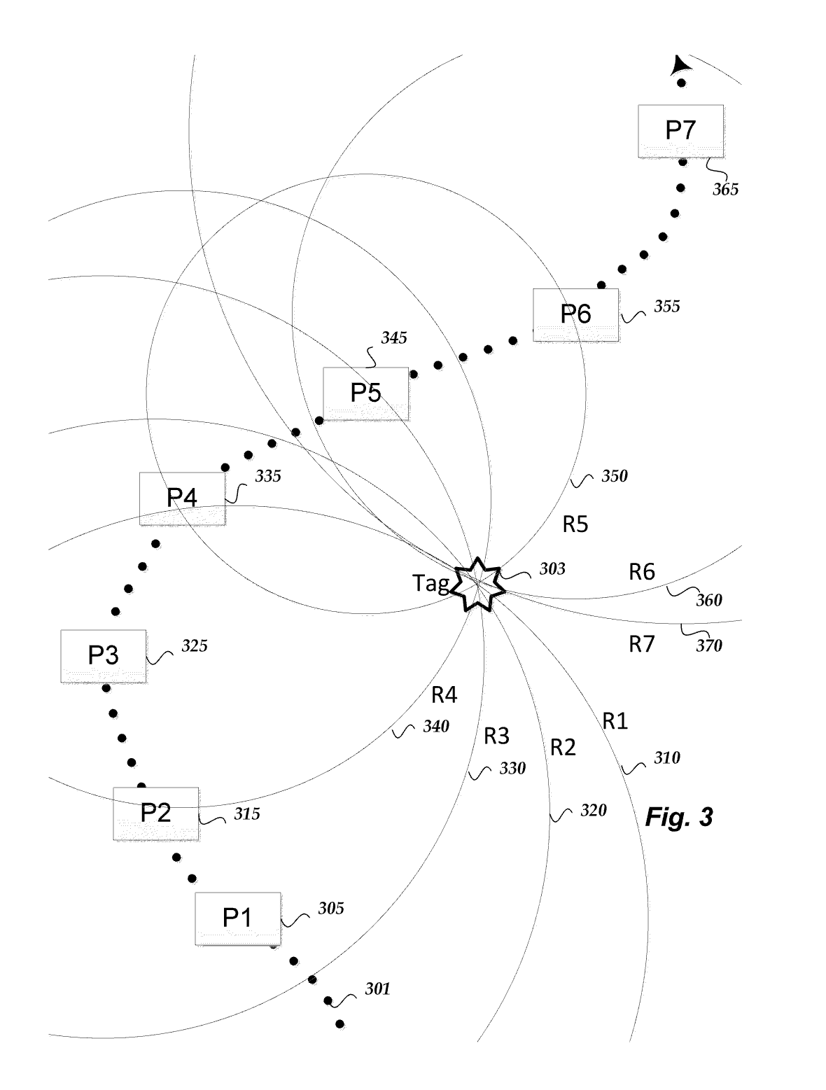

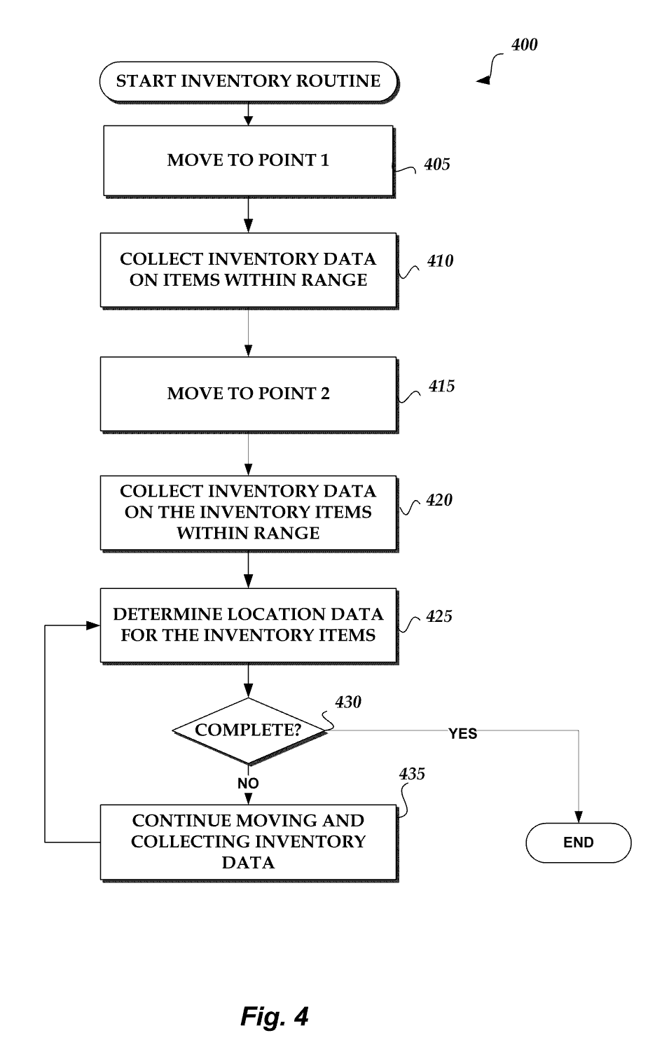

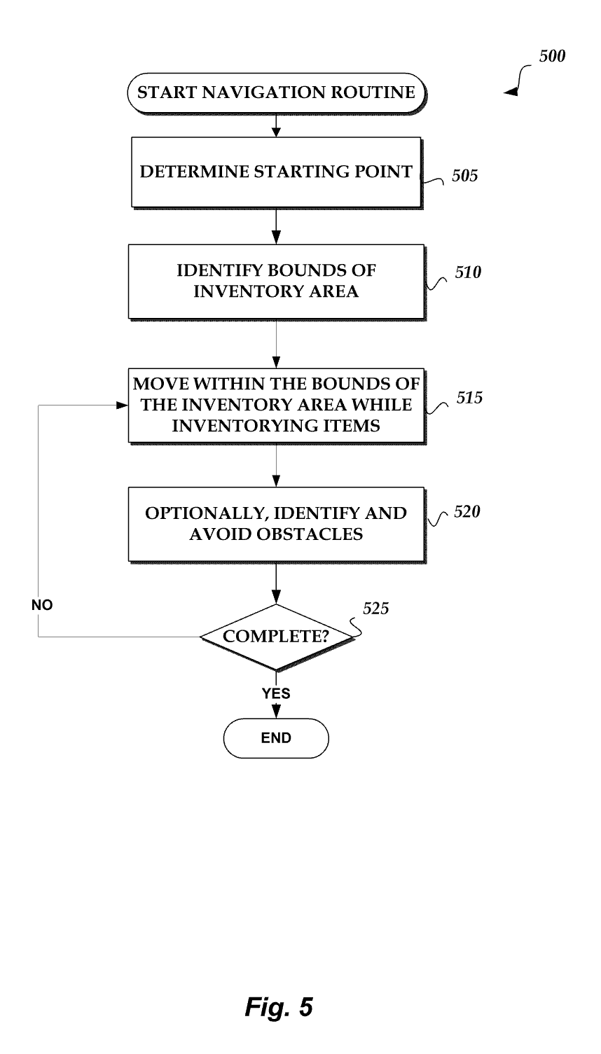

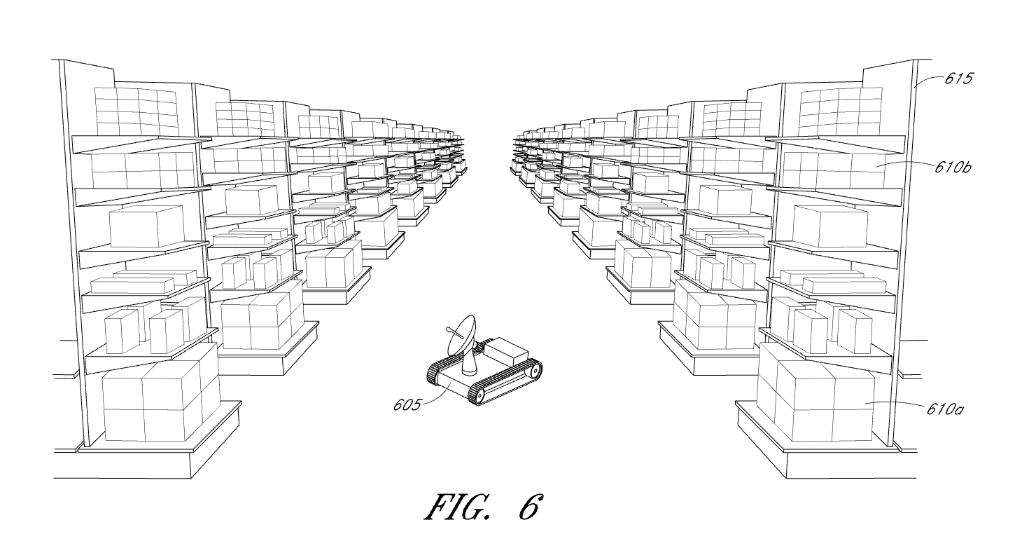

FIG. 2 is a block diagram of an embodiment of the mobile robot 105 of FIG. 1. As illustrated in FIG. 2, the mobile robot can include many components that perform together to provide the desired inventorying functionality. In some embodiments, the mobile robot 105 includes two major subsystems: a navigation system and an inventorying system. The robot may also have other subsystems, such as a power system or communication system.

### Navigation System

In the illustrated embodiment, the mobile robot 105 includes a motor controller 205 that controls a drive motor 210 and a steering motor 215 that drives and/or steers one or more wheels, tracks, or other locomotion devices.

In some embodiments, the drive motor 210 includes one or more electric motors that can be powered by a power source, such as a battery. In some embodiments, the mobile robot 105 uses a tripod style carriage so that, generally, all the wheels are kept on the ground. In some embodiments, the robot 105 includes a single drive wheel 216 and two idler wheels 217a, 217b that are not actively driven. The single drive wheel 216 can be steered by the steering motor 215. In some embodiments, the wheel is configured to be steerable by minimum of 180 degrees. Some embodiments can use additional wheels, different wheel configurations, or other locomotion devices.

In some embodiments, the mobile robot 105 uses a differential speed control system to navigate. In these types of systems, there can be two sets of wheels being driven. The sets of wheel can be attached to continuous tracks or caterpillar tracks. Each set can be connected to a drive train. The drive trains can be driven at different speeds in order to turn or can be driven at the same speed to allow the mobile robot 105 to go forwards and/or backwards. One advantage of the differential speed control system is that it can allow the robot 105 to maneuver in small spaces.

In some embodiments, the mobile robot 105 uses a steered wheel control system, which is similar to a car's steering. The steered wheel control system may be more precise than the differential speed control system. Generally, the steered wheel control system provides smoother turning but may not be able to make as sharp a turn in tight spots.

The mobile robot 105 can include a main controller 220 that can determine the direction or route that the robot travels. The main controller 220 can communicate with the motor controller 205 to pass on movement instructions, which can include direction of movement and movement time.

### Navigation System—Location Tracking

The mobile robot 105 can include a location tracker 225 that determines the current location of the mobile robot 105. The location tracker 225 can report the position of the robot 105 to the main controller 220. In some embodiments, the location tracker 225 includes a dead reckoning system that tracks movement of the robot to determine the robot's position from a starting point. The dead reckoning system can use shaft encoders 227a, 227b on the two idler wheels 217a, 217b to measure the number of revolutions of the wheel and estimate the distance travelled by the mobile robot 105. The dead reckoning system may also collect direction data from the motor controller 205. The dead reckoning system can then use the distance and the direction of travel to estimate the current position of the robot 105.

In some embodiments, the shaft encoders 227a, 227b determine the distance traveled by multiplying the rotations of the wheel with the circumference of the wheel. The orientation of the each wheel can be determined by the ratio of revolutions of one wheel to the other given the fixed distance between the wheels. The orientation can also be derived and/or cross-checked against measurements from a three-axis magnetometer for reasonableness.

In some embodiments, pressure switches and/or attitude sensors can be used on the robot (e.g., on either or both of the idler wheels 217a, 217b) to determine whether the robot is in a level position (e.g., the wheels are in contact with the floor and the robot has not been picked up, tampered with, or driven up an incline or on top of a product or shelf). If the robot 105 is moved, the robot may no longer be able to calculate its position using its previous collected movement data. In that situation, the robot can restart its position calculation, attempt to return to its starting point, and/or derive position data from an external source, such as an electronic emitter or a plurality of electronic emitters as in a GPS system.

In some embodiments, the location tracker 225 can use wireless signals to determine the robot's position. For example, the location tracker 225 can include a receiver that receives a signal from the robot's base station 110, which is typically at the mobile robot's starting location, and can use that signal to determine the robot's 105 location (e.g., by triangulation, signal strength, or other determination method). In some embodiments, the location tracker 225 can combine the dead reckoning system with the wireless signal based location system.

In some embodiments, the mobile robot 105 can use other navigation technologies or a combination of navigation technologies to determine its position and/or search route. While the navigation technologies described above advantageously require minimal setup and/or do not use additional infrastructure in order to simplify operation of the robotic inventory system 100, other navigation technologies can also be used.

For example, the location tracker 225 may derive information about the location of the robot using detection of physical items positioned at one or more locations in the storage area, such as markers or wires in the floor, and/or the location tracker 225 can use electronic communication technologies such as computer vision-devices, lasers, radar, or acoustic information. In some embodiments, the location tracker 225 includes a guide sensor that allows the mobile robot 105 to follow the path defined by markers, such as magnetic or colored tape. In some embodiments, the guide sensor detects wires that have been emplaced onto a floor by detecting a radio frequency transmission or magnetic field from the wires and follows the wires along the route delineated by the wires.

In some embodiments, the location tracker 225 includes a laser transmitter and receiver on a rotating turret. The laser is sent off and reflected from retro reflective tape mounted on the walls, floors, shelves or other surfaces of the store. The angle and/or distance of the reflected laser light can be used to identify the location of the mobile robot 105. For example, the mobile robot 105 can have a reflector map including the locations of the markers stored in memory and can determine its position based on errors between expected and received measurements.

In some embodiments, the location tracker 225 includes a gyroscope and uses inertial navigation. The mobile robot can use transponders embedded in the floor of the store to verify that the vehicle is on course. The gyroscope can detect changes in the direction of the robot 105 and the robot can correct its path. In one embodiment, a three-axis accelerometer can be used to provide similar functionality to the gyroscope. Accelerometers can measure the physical acceleration of an object. Generally, accelerometers are simpler, smaller and/or cheaper than gyroscopes and can be easily integrated into electronics.

### Navigation System—Sensors

The mobile robot 105 can include a sensor controller 230, which can communicate with various sensors to provide obstacle avoidance and/or to determine the boundaries of the space (e.g., a store or warehouse). The sensor controller 230 can communicate the sensor readings to the main controller 220, which can utilize the readings to navigate the mobile robot 105.

The sensors used can include a touch sensor 245 that can determine when the mobile robot hits an obstacle or wall and a light curtain sensor 250 (e.g., a photoelectrical device that detects safety light curtains where the robot should not enter). The mobile robot 105 can also include ultra-sound ranging sensors 255, tilt sensors 260, three-axis magnetometers, and/or various other sensors. The mobile robot 105 can also include a video camera (e.g., normal, low-light, infrared, and/or combination of the above) as an operation recording/verification sensor and to aid in obstacle avoidance. The mobile robot 105 can also use its RFID reader 270 as an obstacle sensor, which can allow detection of items such as tagged clothes on a rack which generally could not be detected with ultrasonic or laser ranging. The use of the RFID reader 270 for obstacle detection is discussed further below.

### Inventorying System

In addition to navigation, the main controller 220 can manage and/or control the mobile robot's inventorying system. The mobile robot 105 can include an RFID subsystem 265 having an RFID reader 270. The RFID reader 270 can be capable of reading a variety of RFID tag protocols, including both active protocols and passive protocols, such as EPC GEN-2 or ISO-18000-6. The main controller 220 can be in communication with the RFID subsystem 265 in order to obtain inventory data.

In some embodiments, the RFID reader 270 includes one or more antennas. In some embodiments, the antennas are optimally directional rather than omni-directional in order to reduce the amount of multi-path signals reaching the reader's antenna during any specific tag communication. Directional antennas may also help in providing some directional information on the tags location. Having an array of multiple antennas on the robot can provide a broader scan area around the robot; this may compensate for the generally more restrictive scan area of a directional antenna. However, in some embodiments, omni-directional antennas or a single antenna can be used.

In some embodiments, the RFID reader 270 includes multiple antennas at different heights to provide multiple path angles between the reader 270 and tag. Reading from different heights and angles can also allow receiving signals from tags that may be shielded or partially shielded by horizontal surfaces, at least from readings from some positions. In some embodiments, the RFID reader 270 includes a Sirit IN610 reader having eight antennas at various heights and orientations, though other readers can be used.

The mobile robot 105 can also include a communication interface 275 for receiving and/or transmitting data over a communications link. The communications link can be via a wired and/or wireless communication link, such as Ethernet, Bluetooth, 802.11 a/b/g/n, infrared, universal serial bus (USB), IEEE 1394 interface, or the like. The mobile robot 105 can use the communication interface 275 to report the inventory data it collects, for example, to the inventory manager 115.

### Power System

The mobile robot 105 can include a power system, having a battery 280 and a charging system 285. In some embodiments, the charging system 285 allows for automatic or opportunistic charging of the mobile robot 105 to provide continuous operation and/or to maintain a full charge when not in use. For example, the mobile robot 105 can be configured to return to the robotic base station 110 of FIG. 1 for charging when idle. In some embodiments, a homing sensor may be included in the robotic base station 110 to allow the mobile robot 105 to locate the base station 110. The robot can then move to the base station 110 for charging.

In some embodiments, the base station 110 is fixed to the floor in a non-movable fashion to provide the mobile robot 105 a stationary reference point for recalibration or registration of the robot's position. For example, the robot 105, if using dead reckoning, can use its relative position to the base station 110 and the base station's known location to determine the robot's location in the store.3

### Location Determination Example

FIG. 3 schematically illustrates an embodiment of a location determination process for an RFID tag. In some implementations, the process is performed by embodiments of the robotic inventory system 100 described with reference to FIG. 1 or by one of its components, such as the mobile robot 105 or inventory manager 115. For ease of explanation, the following describes the process as performed by the mobile robot 105. The example scenario described below is intended to illustrate, but not to limit, various aspects of the robotic inventory system 100.

In some embodiments, the mobile robot 105 moves around the store using a directed or planned routing scheme or using an artificial intelligence (AI) based routing process. While moving around the store, the mobile robot 105 detects and records electronic tag IDs and related data, such as radio frequency (RF) characteristics of the communication link with a particular tag and the position of the robot 105 at the time of the communication link with the particular tag. Over the course of a period of time, the robot can be expected to cover the entire storage area for the store, depending on its size, and identify the inventory items in the store and/or the location of those inventory items.

The information collected by the mobile robot 105 can be processed to give an estimate of the distance of the tag to mobile robot 105. For example, the collected information can place the tag within a detection sphere around the robot's RFID reader 270. The distance covered by the sphere may be dependent on the degree of accuracy for the ranging method.

The information can be used to determine the location of the tag relative to the robot 105, which can include distance and height. For example, the robot 105 may be able to determine if an item is on the floor or off the ground, such as on a shelf or hanging rack. The location information can be used to reconcile inventory location or otherwise determine if something is out of place. For example, the robotic inventory system 100 may have received expected location information for the items in the store, and can use that information to identify items that are not in the expected location. This can help the store organize items or find lost items. For example, an inventory clerk can receive a misplaced item report from the inventory system 100 and the inventory clerk can replace the misplaced items in their correct location.

In some embodiments, the robotic inventory system 100 generates expected location information or “golden tag placement” for the items in the store by recording the location of items during an inventorying operation (e.g., the first such operation at the store) and using that expected location information as a baseline for reconciling inventory location during future inventorying operations. For example, the robotic inventory system 100 can determine if items have moved or if the items in the store have changed since its last inventorying operation by comparing a current scan with the golden tag placement. The robotic inventory system 100 can then report those changes to users of the system, such as the store manager or other store employees.

In FIG. 3, the detection spheres are represented by circles in a two dimensional plane with diameters equal to the range estimate. FIG. 3 illustrates a path 301 the mobile robot 105 may take past a tag 303, along with range estimates (R1-R7) taken at seven discrete points (P1-P7) along the path. The seven readings points are merely exemplary and any number of readings may be taken by the mobile robot. For example, the mobile robot 105 may take readings continuously. At P1 305, the robot takes a range reading of R1 310. At P2 315, the robot takes a range reading of R2 320. At P3 325, the robot takes a range reading of R3 330. At P4 335, the robot takes a range reading of R4 340. At P5 345, the robot takes a range reading of R5 350. At P6 355, the robot takes a range reading of R6 360. At P7 365, the robot takes a range reading of R7 360. The different readings from the robot can then be used to determine the location of the tag 303. For example, the range readings (R1-R7) can be used to triangulate the position of the tag 303 relative to the mobile robot 105.

Additionally the mobile robot 105 can continually monitor the phase shift returning from the tags and, based on changes in the phase as the robot approaches the tag or moves away from the tag, can use the phase shift information to derive, refine, or augment position estimates. For example, the mobile robot 105 can determine when the tag passes the bore-sight of the antenna. Obtaining the mounting angle of the antenna along with the robot's position and orientation can allow the tag 303 to be placed on a line locus. In some embodiments, the line locus, range information and other locus lines generated from other positions can be used to determine a location for the tag 303. In some instances, the mobile robot 105 may be able to estimate a position for the tag 303 based on two or more locus lines, for example, by determining where the two lines locus lines intersect.

In some embodiments, the mobile robot 105 can use the return phase angles at multiple frequencies of signals set from the RFID reader 270 to calculate the range from the tag 303 to the RFID reader. The calculations may compensate for the robot's motion and/or the distortions to the unique phase angle due to the Doppler effect of the motion.

Traditional ranging schemes generally are on a two dimensional chart, where a line defines a slope based on frequency and phase shift. The slope of this line defines the distance or range to the tag from the reader. However, in one embodiment, the robotic inventory system 100 can use a three dimensional graph where the resultant is a surface and not a line. If time is used as the third axis then the slope of the surface along this axis is the speed at which the robot 105 is approaching the tag. Because the mechanical speed and direction at which the robot 105 is traveling can be determined (e.g., using sensors on the robot), the ratio of the speed and the slope along the time axis of the graph can be used to calculate the incidence angle between the robot's motion and the bearing to the tag. Knowing and predicting the shape of these resultant surfaces for different scenarios can allow the robotic inventory system 100 to best fit a measured point to the graph possibilities, allowing the robotic inventory system 100 to solve for both range and bearing, thereby calculating the position of the tag 303.

Several other methods for ranging can be used in addition to or instead of the ranging methods described above. These additional methods can add to the accuracy of the determined tag position. Some embodiments can include measuring the return signal strength from the tag 303 and correlating the signal strength with the distance. For example, a stronger signal from the tag 303 can indicate the tag is relatively closer to the robot 105.

In some embodiments, the mobile robot 105 compares the signal strength of a first, unknown electronic tag with a second tag with a known location to determine the range. For example, if the first tag's signal is stronger than the second tag, where the second tag has a determined range of 20 feet, then the mobile robot 105 can estimate that the first tag is closer than 20 feet. The mobile robot 105 can use additional known tags to refine the estimate. For example, if the first tag is weaker than a third tag with a determined range of 10 feet, the mobile robot can refine the estimate to within 10-20 feet. A fourth, fifth, or even more known tags can be used to further refine the estimate.

Other methods can include incrementally varying the power from the reader and determining the range based on where the readings from the tag 303 drop out. For example, if half power from the reader corresponds to a detection range of 20 feet, while full power corresponds to a range of 30 feet, the tag signal dropping out at half-power indicates the tag is between 20-30 feet from the reader.

In addition, the mobile robot 105 can use its own location tracking functionality to provide a positional reference for location measurements of the tagged items. For example, once the mobile robot 105 determines the relative location of the tagged items to the robot, the mobile robot 105 can then calculate the absolute location of all the tagged items in the store based at least on the relative location of the tagged items and the robot's own position.

In one embodiment, the distance between the robot 105 and the tag 303 is calculated using an indirect propagation delay measurement. For example, a frequency hopping scheme can be used to measure the relative phase offset of the received signal between the various frequencies. For a given distance between objects, the phase offset versus the frequency curve is a straight line with the slope dependent upon the measured distance. After the phase of the received signals is detected, the data is plotted on a curve and the slope is calculated.

In one embodiment, the distance between the robot 105 and the tag 303 is calculated using phase ranging. For example, phase readings can be collected by monitoring reply signals from the RFIDs tags corresponding to interrogation signals at multiple frequencies and a common interrogation signal beam direction. The measured phase and frequency data can be compared with theoretical phases calculated with respect to the same frequencies over a range of positions corresponding to a beam extent of the interrogation signal in order to determine the distance.

### Example Embodiments of Inventory and Navigation Routines

FIG. 4 illustrates a flowchart of an embodiment of an inventory routine 400. The inventory routine or process 400 can be used, for example, by the robotic inventorying system 100 or other portions of the system illustrated in FIG. 1, such as the mobile robot 105. Depending on the embodiment, the process of FIG. 4 may include fewer or additional blocks and/or the blocks may be performed in a different order than is illustrated. For ease of explanation, the process is described herein as performed by the mobile robot 105; however, the method may be performed wholly or partially by any other suitable computing device or system.

Beginning at block 405, the mobile robot 105 moves to point 1 on its search route through a store. Point 1 can be any arbitrary point on the route. The robot can stop at point 1 or can keep moving while it passes through point 1. In some embodiments, the mobile robot 105 tracks its movement in order to determine its position in the store.

The route may be predetermined or may be dynamically determined by the mobile robot 105 while it moves in a store. For example, the robot may be determining its route based on the feedback it receives while moving.

At block 410, the mobile robot 105 collects inventory data on inventory items within its detection range. In some embodiments, the mobile robot 105 detects RFID tags associated with the inventory items.

The collected inventory data can include data transmitted from the RFID tags, such as identification data for the inventory items (e.g., item ID, RFID ID or item description), data from the mobile robot 105, and characteristics of communication link between the reader and the tag, such as phase angle, frequency, receive signal strength, transmit power, bit error rates and read rate. For example, the robot 105 can record its current location, the orientation and direction of its RFID reader 270, the strength of the signal received from the RFID tags, an estimate of the item location, or other inventory data.

In some situations, the robot 105 may not be able to detect some items that should be within its detection range. For example, the signal from some RFID tags can be blocked by obstacles in the transmission path, such as shelves, other items or other objects. However, as the robot moves, the transmission path from the robot to the tags changes, which can allow the robot to detect previously blocked signals.

At block 415, the mobile robot moves to point 2 on its search route. As discussed above with reference to point 1, point 2 can be any arbitrary point on the route. The robot can stop at point 2 or can keep moving while it passes through point 2.

At block 420, the mobile robot 105 collects inventory data on inventory items within its detection range. As discussed above, the collected inventory data can include data transmitted from the RFID tags, such as identification data for the inventory items, and data from the mobile robot 105.

At block 425, the mobile robot 105 determines location data for the inventory items. As discussed above in relation to FIG. 3, many different methods can be used to determine the location data of the inventory items based on the collected inventory data.

In some embodiments, the robotic inventory system 100 calculates or estimates the range between a tag and a reader, the relative motion between the tag and the reader, and/or the angle of the reader to the tag based on the collected inventory data using various location techniques.

In some embodiments, the robotic inventory system 100 may generate X-Y-Z coordinates (e.g., 3-dimensional coordinates) for the inventory items based on the collected inventory data. The robotic inventory system 100 may assign a confidence score or quality measure to the coordinates that indicate the degree of certainty for each estimated location of the inventory item. The confidence score may also be assigned for embodiments using an X-Y or 2-dimensional coordinate system to identify inventory item locations. The coordinates generated by the robotic inventory system 100 can represent the absolute location of inventory items within the store.

At block 430, the mobile robot 105 determines whether it has completed inventorying the store. For example, the mobile robot 105 can determine, based on an estimated detection range, whether the path it has travelled has covered the entire store. There may be some parts of the store (e.g., locked rooms) that the mobile robot 105 cannot reach. In some embodiments, the robot 105 can identify places that it has not been able to find a path to and disregard those places in determining whether inventorying is complete. The inventorying process 400 can then end.

In some embodiments, the robotic inventory system 100 creates a grid of the area being scanned (e.g., the store) based on the boundaries of the area. The boundaries may be provided as an initial parameter or determined during an initial navigation boundary scan, described in further detail FIG. 5. The robotic inventory system 100 can place known mechanical objects or obstacles found on a point or area on the grid. It can also include additional information, such as which sensor detected the obstacle and how many times the robot 105 has traversed a particular grid point or area. The robotic inventory system 100 can include all tagged items found during the inventorying process 400 in the grid. The robotic inventory system 100 can calculate a coverage quality factor based at least partly on how close and/or how often the robot passed a particular grid point or area.

The robotic inventory system 100 can also use the grid to see if some elements of the scan area require more coverage. For example, if the mean reading range of the robot is 10 feet and over the course of the scan the robot's closest pass to a particular grid point or area is only 15 feet, then the robot's scan is not yet complete and inventorying can continue.

If the mobile robot 105 determines that inventorying is not yet complete, the process 400 can proceed to block 435. At block 435, the mobile robot 105 continues moving on the search route and collecting inventory data. The process 400 can then proceed back to 425 to determine the location data for the inventory items, including determining the location of newly detected inventory items and refining the location estimates of previously detected inventory items. The inventorying process 400 can then proceed to block 430 and continue as described above.

In some embodiments, the results of the inventorying process 400 can be used as the basis for future scans. For example, the robotic inventory system 100 can use the grid for a past scan as a “golden obstacle map” that can be used to determine a route through the store. In one embodiment, the robotic inventory system 100 uses the grid to determine a route that avoids obstacles and/or that efficiently covers the previous locations of items (e.g., using various shortest path algorithms such as Dijkstra's algorithm or the like). This can speed up the inventory process 400.

As described above, the robotic inventory system 100, in some embodiments, can “self-learn” by using the past scans to plan future scans. In some embodiments, the robotic inventory system 100 may keep multiple past scans and can combine some or all of them to plan a future scan. However, in some embodiments, a user can adjust or modify how the robotic inventory system 100 plans its scan. For example, in some situations, such as when the store's layout has been changed, using the previous grid may slow the inventory process 400, so providing an override can be beneficial.

FIG. 5 illustrates a flowchart of an embodiment of a navigation routine 400. The navigation routine or process 400 can be used, for example, by the robotic inventorying system 100 or other portions of the systems illustrated in FIG. 1, such as the mobile robot 105. Depending on the embodiment, the process of FIG. 4 may include fewer or additional blocks and/or the blocks may be performed in a different order than is illustrated. For ease of explanation, the method will be described herein as performed by the mobile robot 105; however, the method may be performed wholly or partially by any other suitable computing device or system.

In some embodiments, the mobile robot 105 receives a map of the inventory area and a search route for the inventory area. The robot 105 can then move along the indicated search.

However, in some embodiments, the mobile robot 105 does not receive a map or a search route but explores its surrounding area and determines the search route based on its exploration. This allows the robotic inventory system 100, in some embodiments, to simplify the setup or installation process for the system 100 by not requiring a user to provide a search route or map.

Beginning at block 505, the mobile robot 105 determines its starting point. The starting point can be where the robot initially starts the inventorying process. In some embodiments, the starting point corresponds with the location of the robotic base station 110 of FIG. 1. In some embodiments, the starting point is along a wall on the outer perimeter of an inventory area. Initially, the mobile robot 105 can be facing into the store or along a line parallel to the wall. The placement of the mobile robot 105 can facilitate certain of the navigation algorithms described below.

At block 510, the mobile robot 105 identifies the bounds of the inventory area (e.g., a store). In some embodiments, the mobile robot 105 finds the perimeter of the inventory area by using a left hand or right hand maze solving algorithm (also called the “wall follower” algorithm) or a variation thereof. Under this algorithm, the mobile robot 105 keeps the wall along one of its sides (e.g., left or right) until it reaches it's starting point. Generally, since the inventorying process typically occurs when a store or warehouse is closed, the mobile robot 105 is typically in an enclosed area. By following the algorithm, the mobile robot 105 can return to the starting point. Other search algorithms may be used (e.g., the Pledge algorithm). In some embodiments, the mobile robot 105 can be configured to move in a generally straight line until it encounters an obstacle, at which point it can turn and/or back-up and then proceed in another straight line until over time it has traversed a sufficient amount of the store floor to account for the electronic tags within the bounds of the defined area.

At block 515, the mobile robot 105 moves along a search route within the bounds of the inventory area while the mobile robot is inventorying items. For example, in some embodiments less than the full area of a store is desired to be inventoried and the mobile robot 105 can confine its inventorying to that area. In some embodiments, the search route can be determined by the robotic inventory system 100 before the robot 105 begins inventorying or the search route may be dynamically determined while the robot is moving through the inventory area. In some embodiments, the mobile robot 105 performs the inventory process described in FIG. 4 while it moves through the inventory area.

At block 520, the mobile robot 105 can, optionally, identify and avoid obstacles. In some embodiments, the mobile robot 105 can use sensors (e.g., the sensors described in FIG. 2) to detect obstacles. In some embodiments, the mobile robot 105 utilizes RFID readings to identify obstacles. Generally, items in the store are tagged with an RFID tag and the items are placed on shelves, racks or other storage places. Typically, these same storage places form obstacles for the mobile robot 105 or the items themselves can be obstacles to the robot. Therefore, in some embodiments, the mobile robot 105 can avoid at least some obstacles by avoiding direct contact with areas determined to contain inventory items. This can speed up the inventorying process.

At block 525, the mobile robot 105 determines whether it has completed inventorying the inventory area. For example, the mobile robot 105 can determine, based on an estimated detection range, whether the path it has travelled has covered the entire inventory area. There may be some parts of the inventory area (e.g., locked rooms) that the mobile robot 105 cannot reach. In some embodiments, the robot 105 can identify places that it has not been able to find a path to and disregard those places in determining whether inventorying is complete.

If the inventorying process is complete, the navigation process 500 can then end. If not complete, the navigation process can proceed back to block 515. The navigation process 500 can loop multiple times until the robot is finished inventorying the inventory area.

In some embodiments, the mobile robot 105 may continue moving until its detection range has covered all the areas (or some areas) of the inventory area a certain number of times. For example, in one implementation, the robot 105 continues moving until the mobile robot passes within the detection range of areas of the inventory area at least twice. By building some overlap into the search, the robotic inventorying system 100 can increase accuracy of the inventorying process by providing another change for missed items to be detected.

In some embodiments, the mobile robot 105 saves the search route calculated by the navigation routine 400. The mobile robot 105 can then use the search route during a next inventorying process. In some situations, the mobile robot 105 can modify the saved search route or recalculate the search route to account for changes the robot encounters. For example, the mobile robot 105 may have to modify the search route if the floor plan of the store has been changed or obstacles in the store have been moved.

FIG. 6 illustrates an example depiction of a mobile robot 605, such as the robot 105 of FIG. 1, moving through a store while detecting tags associated with items 610a, 610b in the store. The items 610a, 610b can be located on shelves 615 or other storage areas. In some embodiments, the mobile robot 605 identifies and avoids obstacles, such as the shelves 615.

Many variations on the robotic inventorying system 100 described above are possible. For example, while the above description generally describes functions as performed by the mobile robot, at least some of those functions can be performed by the inventory manager or other component of the robotic inventory system. Likewise, at least some functions described as performed by the inventory manager system or robotic inventory system can be performed by the mobile robot. For example, the inventory manager may be incorporated into the robot or the robot can perform at least some calculations or processes for the robotic inventory system using its own onboard systems.

Other variations are also possible. For example, In some embodiments, the mobile robot can be used to monitor an area, such as an exit or dressing room, when the mobile robot is not conducting inventorying operations. The robot can be placed near an exit and configured to generate an alarm signal if a tagged item passes the exit of the store. In another example, while the above description generally describes RFID tags, other electronic tags can be used by the robotic inventory system.

As described above, the robotic inventorying system 100 can be implemented with one or more physical servers or computing machines, such as several computing machines interconnected via a network. Thus, each of the components depicted in the robotic inventorying system 100 can include hardware and/or software for performing various features.

The processing of the various components of the robotic inventorying system 100 can be distributed across multiple machines, networks, and other computing resources. Moreover, in some embodiments the connections between the components shown represent possible paths of data flow, rather than actual connections between hardware. While some examples of possible connections are shown, any of the subset of the components shown can communicate with any other subset of components in various implementations.

In some embodiments, the robotic inventorying system 100 may be configured differently than illustrated in the figures above. For example, various functionalities provided by the illustrated modules can be combined, rearranged, added, or deleted. In some embodiments, additional or different processors or modules may perform some or all of the functionalities described with reference to the example embodiment illustrated in the figures above. Many implementation variations are possible.

In some embodiments, a server computing system that has components including a central processing unit (CPU), input/output (I/O) components, storage, and memory may be used to execute the robotic inventorying system 100 or specific components of the robotic inventorying system 100. The executable code modules of the robotic inventorying system 100 can be stored in the memory of the server and/or on other types of non-transitory computer-readable storage media. In some embodiments, the robotic inventorying system 100 may be configured differently than described above.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer-readable medium or tangible computer storage device, such as hard drives, solid state memory, optical disc, and/or the like. The systems and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, is not generally intended to imply that features, elements and/or steps are required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein.

The following is claimed:

1. A mobile robotic device for inventorying items, the mobile robotic device comprising:
a navigation module configured to identify the boundaries of an inventory storage area and automatically determine a search route through the inventory storage area;
a propulsion module configured to receive the search route from the navigation module and move the mobile robotic device along the search route;
an RFID reader configured to receive multiple RFID readings from RFID tags associated with inventory items, the multiple RFID readings received along multiple locations along the search route; and
an inventory locator module, the locator module configured to identify the location of inventory items within the inventory storage area based at least partly on the multiple RFID readings from the multiple locations.

2. The robotic device of claim 1, further comprising a location tracking module configured to determine location data for the mobile robotic device.

3. The robotic device of claim 2, wherein the inventory locator module is configured to determine the location of the inventory items based at least partly on the location data for the mobile robotic device.

4. The robotic device of claim 2, wherein the location tracking module includes a dead reckoning system for determining the current location.

5. The robotic device of claim 1, wherein the search route is updated based at least partly on detected obstacles.

6. The robotic device of claim 5, wherein the detected obstacles include inventory items identified by their associated RFID tags.

7. The robotic device of claim 1, wherein the search route is calculated based at least partly on a previous inventory scan of the inventory storage area.

8. A robotic inventory system for inventorying items, the system comprising:
a mobile robot having an electronic tag reader configured to receive electronic tag data from electronic tags associated with inventory items;
a navigation module configured to determine a search route through an inventory area and direct the mobile robot to move along the search route; and
an inventory identification module configured to receive the electronic tag data from the mobile robot and identify the inventory items in the inventory area based at least partly on the electronic tag data;
wherein the mobile robot is configured to collect multiple readings from one or more of the electronic tags associated with the inventory items, the multiple readings taken at multiple locations along the search route.

9. The robotic system of claim 8, further comprising an inventory location module configured to identify the location of the inventory items within the inventory storage area based at least partly on the multiple readings from the multiple locations.

10. The robotic system of claim 9, wherein the inventory location module is configured to identify the location of the inventory items by triangulating the location of the inventory items from the multiple readings from the multiple locations.

11. The robotic system of claim 8, wherein the mobile robot collects signal characteristics of the multiple readings, including signal strength.

12. The robotic system of claim 11, further comprising an inventory location module configured to identify the location of the inventory items within the inventory storage area based at least partly on the multiple RFID readings and the signal characteristics of the multiple readings.

13. The robotic system of claim 8, wherein the electronic tags are RFID tags.

14. The robotic system of claim 8, wherein electronic tag reader includes directional antennas.

15. The robotic system of claim 8, wherein the electronic tag data is used to identify obstacles in the search route and the navigation module is configured to update the search route based on the identified obstacles.

16. A method for inventorying a storage area using a mobile robot, the method comprising:
moving the mobile robot to a first area;
collecting inventory data related to the one or more RFID tags associated with inventory items using an RFID reader from the first area;
moving the mobile robot to a second area;
collecting inventory data related to the one or more RFID tags using the RFID reader from the second area; and
determining location of the inventory items based at least partly on the inventory data collected from the first area and the second area.

17. The method of claim 16, wherein the inventory data includes the location of the first area and the second area.

18. The method of claim 17, wherein determining the location of the inventory items comprises:
determining a first range to the one or more RFID tags from the mobile robot at the first area;
determining a second range to the one or more RFID tags from the mobile robot at the second area; and
determining the location of the inventory items in the storage area based at least on the first range, the second range, and the locations of the first area and the second area.

19. The method of claim 18, wherein the first range is calculated based on return phase angles at different frequencies of signals sent from the RFID reader.

20. The method of claim 16, wherein the inventory data includes signal strengths of the signals received from the one or more RFID tags.

21. The method of claim 20, wherein determining the location of the inventory items is based at least partly on the signal strengths of the signals from the one or more RFID tags.

22. The method of claim 16, wherein determining the location of the inventory items is performed on the mobile robot.

23. The method of claim 16, wherein determining the location of the inventory items is performed on an inventory management system separate from the mobile robot after the mobile robot communicates the inventory data to the inventory management system.
